(19) United States
(12) Patent Application Publication
(10) Pub. No.: US 2020/0296925 A1
(43) Pub. Date: Sep. 24, 2020

(54) DEVICE FOR, SYSTEM FOR, METHOD OF IDENTIFYING AND CAPTURING INFORMATION ABOUT ITEMS (FISH TAGGING)

(71) Applicants: Andrew Bennett, Belmont, MA (US); Thomas Flanigan, Vienna, VA (US); Silas Hughes, Somerville, MA (US); Kathy Wienhold, Arlington, MA (US)

(72) Inventors: Andrew Bennett, Belmont, MA (US); Thomas Flanigan, Vienna, VA (US); Silas Hughes, Somerville, MA (US); Kathy Wienhold, Arlington, MA (US)

(21) Appl. No.: 16/699,595

(22) Filed: Nov. 30, 2019

Related U.S. Application Data
(60) Provisional application No. 62/773,548, filed on Nov. 30, 2018.

(51) Int. Cl. A01K 11/00; G06K 7/10; A01K 69/06

(52) U.S. Cl. CPC A01K 11/006; A01K 85/00; A01K 69/06; G06K 7/10297

(57) ABSTRACT

Disclosed are systems and methods of identifying and capturing information about items. In this instance, the systems and methods are focused upon fish. Through the use of the disclosed systems and methods, fish can be tagged and/or the image of the fish can be captured. The information about the tagged and/or image-captured fish can be wirelessly communicated to a remote device. As desired, the information specific to the fish can be combined and uploaded into a database with other relevant information, such as location information, temperature readings, latitude, longitude, date, time, and more.

### BACKGROUND

The identification and tracking of various items have long been activities engaged in by people responsible for managing such items. Such activities have been part of the management of, for example, livestock in the fields, merchandise in the warehouses, crops transported from farmers to processing plants, fish in migration, or any other sets of items that are part of any or any other ecosystem. As technology has advanced, the tools and systems used to identify and track such items have also improved.

For example, in the area of fishing, U.S. patent application Serial No. US2004/0220856 A1 (the “Moore Application”) discloses a method of catching, releasing and encouraging others to catch tagged fish. Each fish is identifiable by a tag. The prior art disclosed in the reference, however, is limited in its functionality. For example, although the device and the method allows users to tag fish, other desirable functionalities, such as capturing an image of the fish and/or audio recording of information about the fish, its location, its capture, its release or other details are not disclosed or suggested. Further, there is no meaningful disclosure or suggestion regarding the integration of the device in the Moore Application or the method disclosed therein with other devices or methods that could, for example, compliment data with date, time and location information. Such integrations would allow the users to have more information associated in real-time with one or more fish and more flexibility in how they manage the information. There is also no teaching or suggestion in the Moore Application regarding the association of the information gather and generated with a specific user (for example, a unique operator using the device in the Moore Application and/or practicing its method).

With the foregoing describing some of the shortfalls of the prior systems and methods, the present inventions (both the systems and the methods) are designed and have been developed to address these considerations and other challenges in the prior art.

### I. CAPTURING INFORMATION ABOUT FISH

### Summary Of The Invention

The present invention, in general, comprises systems for, and methods of identifying and capturing information about items. One of the fish tagging embodiment of the present inventive systems comprises, in its broadest sense, frame, wireless technology, a RFID reader or its functional equivalent, a bait holder or other lure, a sensor, an ejector, and a multi-axis tagging actuation assembly. Unlike as taught in the prior art, in a preferred embodiment, the communications between the RFID reader (or its functional equivalent) and an applicable remote device (e.g. a phone, tablet or computer) electronically connected to such reader via the wireless technology facilitates the creation of an integrated database. For example, the combination of connected elements could simultaneously, or in near real time, record tag numbers (e.g., via the reader or a cameral if the tag has a visible number on it) and location information, temperature readings, latitude, longitude, date, time, and more (e.g., via the remote device). Thus, the wireless technology can, for example, facilitate communication between, the RFID reader (or its functional equivalent) and smartphones, computers and other elements with transmitters and/or receivers and data storage capacities. Accordingly, the system therefore could be capable of providing information in a form in which it can be stored until it can be uploaded. Related to one embodiment of the inventive system is a method of tagging fish.

Another embodiment of the inventive systems does not include tagging functionality as a base element. This version of the present inventive system could be used for, for example, identifying fish through captured images. In one embodiment of this particular system, the element used to collect information could be an image-capture element, as opposed to being a tagging element. In addition, the in-water system could include a multi-axis viewing actuation assembly to which the image-capturing element could be mounted. This viewing actuation assembly could move the image-capturing element in relation to a passage through which fish are directed. The fish could be drawn into the passage by bait/lure positioned in a desirable location relative to such passage and the viewing actuation assembly. A sensor can inform the system of the presence of the fish and an ejector, along with an acoustic link and/or release, could facilitate the exiting of the fish (x) after the image of the fish has been captured (if warranted, e.g., if the fish does not exit on its own) or (y) if it is determined that a captured image is not needed. Related to one embodiment of the inventive system is a method of capturing the image of fish.

### BRIEF DESCRIPTION OF THE FIGURES

FIG. 1 shows an embodiment of the present inventive system usable in-water for tagging fish, inclusive of a frame, power source, wireless technology, a tag reader, a fish lure, a sensor, a fish ejector, and multi-axis tagging actuation assembly.

FIG. 2 shows a flowchart depicting the present inventive method of tagging fish.

FIG. 3 shows an embodiment of the present inventive system usable in-water for capturing images of fish, inclusive of a frame, power source, wireless technology, an imagine capturing element, a fish lure, a sensor, a fish ejector, and multi-axis viewing actuation assembly.

FIG. 4 shows a flowchart depicting the present inventive method of capturing an image of a fish.

### DETAILED DESCRIPTIONS OF THE EMBODIMENTS

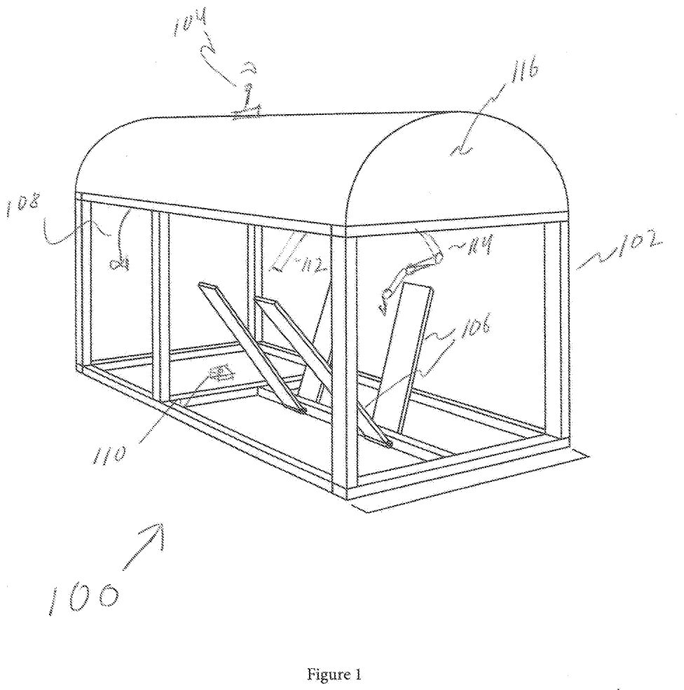

In a particular embodiment of the present invention, the focus of the inventive system is fish tagging. As shown in FIG. 1, system 100 comprises, in its broadest sense, frame 102, wireless technology 104, reader 106, fish lure 108, sensor 110, fish ejector 112, and multi-axis tagging actuation assembly 114. As embodied, system 100 could be located in the water (e.g., remote from the location of the information receiving device). It is currently anticipated that present inventive system 100 could be used for, for example, fish tagging and the later updating, maintenance and logging, of information about the fish in question and the circumstances and conditions surrounding the tagging. In a preferred embodiment of the present invention, the communications between reader 106 (or its functional equivalent) and an applicable remote device (e.g. a phone, tablet or computer) electronically connected to reader 106 via wireless technology 104—which is electronically and physically connected to reader 106, facilitates the creation of a database of information. Wireless technology 104, reader 106, sensor 110, fish ejector 112, and multi-axis tagging actuation assembly 114 are connected to and powered by power source 116. Accordingly, the combination of the foregoing connected elements, with the remote device, could simultaneously, or in near real time, record tag numbers (e.g., via reader 106) and location information, temperature readings, date, time, and more (e.g., via the remote device). Thus, wireless technology 104 can, for example, facilitate communications and data storage capacities. Further, system 100 therefore could be capable of providing information in a form in which it can be stored and the combined information can be stored locally and/or uploaded to one or more databases when a network is available. One of ordinary skill in the art would know that, although the use of the present invention as described above is contemplated for fish in water, versions of the same could be used for other animals and on land. In addition, one of ordinary skill in the art would know that the individual components of the embodiment could be operated, as warranted, individually or jointly, and/or in parallel or in series.

Multi-axis tagging actuation assembly 114 could move, in relation to frame 102 upon which assembly 114 is mounted, in and out of the passage of frame 102 (i.e., through which fish are directed for orientation to be tagged). The fish could be drawn into the passage by lure 108 mounted on frame 102 and positioned in a desirable location relative to such passage and tagging actuation assembly 114. Sensor 110, also mounted on frame 102, can inform system 100 of the presence of the fish. Fish ejector 112, which could comprise, for example, an acoustic link and/or release, could facilitate the exiting of the fish (if the fish does not exit on its own) after the fish is tagged (if warranted) or identified as not needing to be tagged.

One of ordinary skill in the art would know that there are a number of elements and devices that could provide the functionality and capacities of wireless technology 104, reader 106, sensor 110, multi-axis tagging actuation assembly 114, power source 116, or any of the elements of the embodiment. Accordingly, the present invention is not limited to the specific elements specifically mentioned above.

In an enhanced version of the embodiment of the present invention shown in FIG. 1, system 100 could additionally include recording capabilities, such as, for example, elements that could record images (photographs), sounds, positions, etc. attached to frame 102. Alternatively, reader 106 could be equipped to record information directly, which could then be transmitted via wireless technology 104 to one or more remote devices. The recorded information could thereafter be further and/or later analyzed.

An additional or alternative enhancement to system 100 could be data storage. Such storage to support the independent use of system 100 over time in a fixed geographical location where system 100 could record and store data for retrieval later in time. For example, after a week's independent operation, the user could return to the location of system 100 and retrieve, via wireless technology 104, data in a data storage element, powered, for example, by power source 116 or its functional equivalent. Operating as such, system 100 therefore stores information until it can be downloaded and, possibly later, uploaded into one or more other devices. In another version of system 100, data storage can be expendable and released, with a Satcomms/GPS unit attached, to the surface, where the Satcomms/GPS unit could transmit the data to biologists and/or be recovered. If security/traceability/history is a concern, the information can be secured with blockchain technology, which then could be used to monitor if a record was changed in any way.

An example of the use of the present invention shown in FIG. 1 is in the tagging and recording of information about deep-water fish. The foregoing is notable with respect to several deep-water fish species that are vital to the food security of the Hawaiian Islands. These fish cannot be tagged and released because the act of catching them and bringing the fish to shallow waters can kill the fish due to pressure changes. Similarly, there are species of benthic fish whose patterns of migration are unknown since there is no current capability to tag such fish without killing them. If such tagging were done, it would be possible to learn more about the motion of such fish from when they are initially tagged to when they are caught or observed again. Through the use of the present invention, such deep water species could be tagged in situ (such that they never leave their native environment).

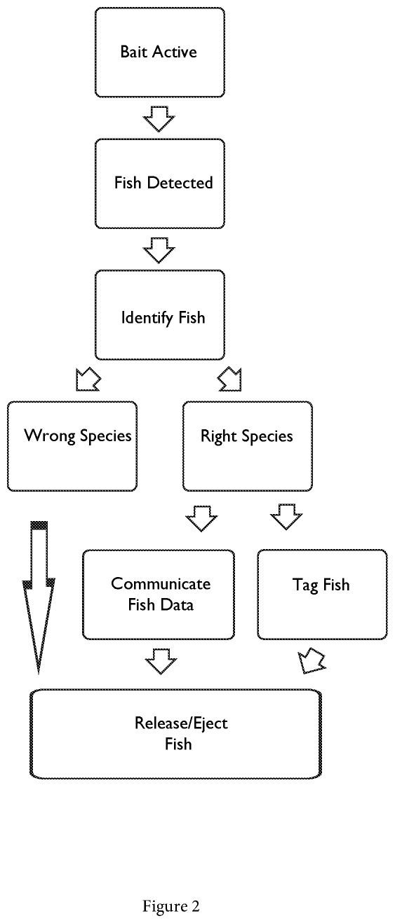

FIG. 2 shows a flowchart that captures the inventive method of, in this instance, tagging fish. The method includes the steps of (A) positioning bait or other lure in a fixed location to facilitate the swimming of fish through a passage into the tagging area at such fixed location, (B) detecting fish passing toward the tagging area, (C) redirecting a fish (by startling them, if necessary) for ejection if such fish is not a member of the correct species (i.e., not one of the species to be tagged), (D) scanning a fish identified as members of the species for tagging, (E) tagging a fish of the correct species, after identifying a spot on the fish for the tag, and (F) logging the tag information, along with remotely logged date and time images relevant to the fish tagging. In an enhanced version of the inventive method, the process includes the additional steps of (G) capturing images of fish passing through the tagging area, (H) using a tagging actuation assembly to position the tagger element at the correct position to attach the tag to the fish, (I) directing the fish (e.g., with additional shock and/or pain if necessary) so that it will pass completely through the tagging area, (J) releasing a weight, when the last tag is used or when the power is nearly exhausted, to allows the device to float to the surface for collection, (K) transmitting a GPS, satellite and/or other signal to researchers so they will know where to recover the device or (L) various combinations of the foregoing additional steps with the initially presented set of steps (A)-(F).

When the tagger can be placed by the biologists, its location can be registered with information pertinent to the biologists' work. This locational information could be associated with other data for applicable analysis and study. Also, by way of further example, the device could be triggered to release the weight, so the device can float to the water's surface, via an acoustic release. In still another version of the present inventive method, the tagger can be expendable and instead release an attached Satcomms/GPS unit to the surface where the released unit element can transmit the tagger data to biologists and/or be recovered.

When an image-capture element can used as part of the inventive process, its location and the captured images can be registered with other information pertinent to the biologists' work. This locational information could be associated with other data for applicable analysis and study. Also, by way of further example, the device could be triggered to release the weight, so the device can float to the water's surface, via an acoustic release. In still another version of the present inventive method, the image-capturing element can be expendable and instead release an attached Satcomms/GPS unit to the surface where it can transmit the captured images and other data to biologists and/or be recovered.

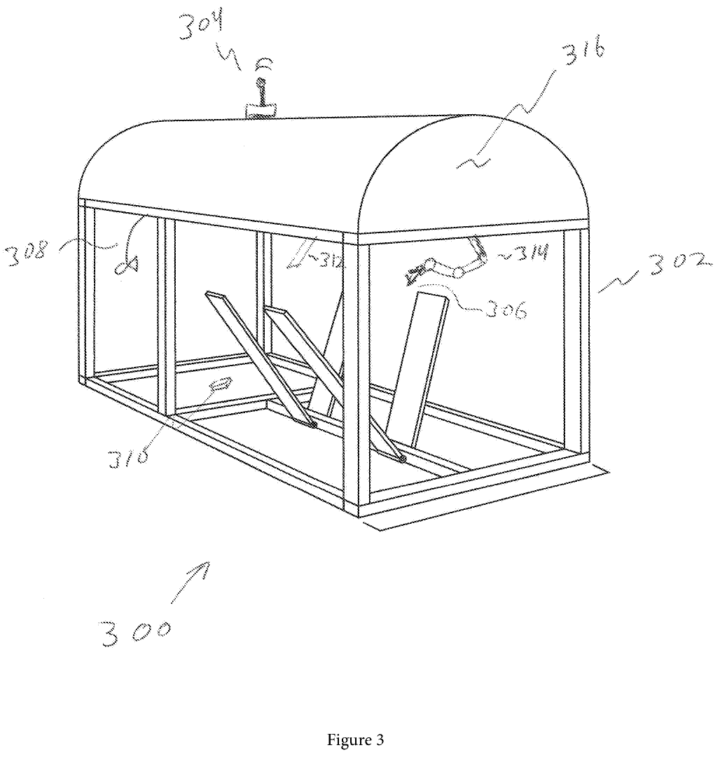

In another particular embodiment of the present invention, the focus of the inventive system is fish image-capturing. As shown in FIG. 3, system 300 comprises, in its broadest sense, frame 302, wireless technology 304, image-capturing element 306, fish lure 308, sensor 310, fish ejector 312, and a multi-axis viewing actuation assembly 314. As embodied, system 300 could be located in the water (i.e., remote from the location of the information receiving device). It is currently anticipated that present inventive system 300 could be used for, for example, fish viewing and recording images of fish and later logging, updating and maintaining information about the fish recorded. In a preferred embodiment of the present invention, the communications between image-capturing element 306 (or its functional equivalent) and an applicable remote device (e.g. a phone, tablet or computer) electronically connected to image-capturing element 306 via wireless technology 304, which is electronically and physically connected to image-capturing element 306, facilitates the creation of a database of information. Wireless technology 304, image-capturing element 306, sensor 310, fish ejector 312, and multi-axis viewing actuation assembly 314 are connected to and powered by power source 316. A combination of the electronically connected elements could simultaneously, or in near real time, record images (e.g., via image-capturing element 306) and location information, temperature readings, date, time, and more (e.g., via the remote device). Wireless technology 304 can, for example, facilitate such communications and data storage. System 300 therefore could be capable of providing information in a form in which it can be stored and the combined information can be stored locally and/or uploaded to one or more databases when a network is available. One of ordinary skill in the art would know that, although the use of the present invention as described above is contemplated for fish in water, versions of the same could be used for other animals and on land. In addition, one of ordinary skill in the art would know that the individual components of the embodiment could be operated, as warranted, individually or jointly, and/or in parallel or in series.

One application/use of the present embodiment of the present inventive system could be in image-capturing fish that could not survive in shallow water or at atmospheric pressure. Noting, as mentioned above, that several deep-water fish species are vital to the food security of, for example, the Hawaiian Islands, monitoring these fish is an important activity. These fish cannot be image-captured outside of pressure in the water under which they live and released because the act of catching them and bringing the fish to shallow waters could kill the fish due to pressure changes. Similarly, there are species of benthic fish whose patterns of migration are unknown since there is no current capability to image-capture/uniquely-identify such fish without killing them. It is contemplated that image-capturing such fish through the use of the present inventive system (i.e., through a system in situ such that the fish never leave their native environment) will make it possible to learn more about the motion of such fish from when they are initially image-captured to when they are caught or observed again.

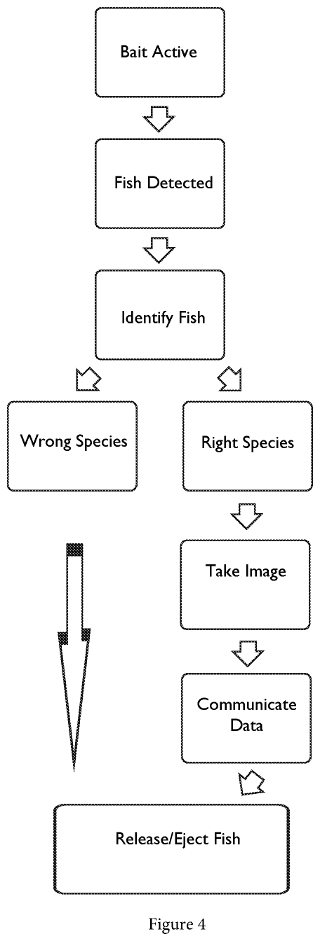

FIG. 4 shows a flowchart that captures the inventive method of, in this instance, capturing images of fish. The method includes the steps of (A) positioning bait or other lure in a fixed location to facilitate the swimming of fish through a passage into the image-capturing area at such fixed location, (B) detecting fish passing toward the image-capturing area, (C) redirecting a fish (by startling them, if necessary) for ejection if such fish is not a member of the correct species (i.e., the image of the species is not needed), (D) scanning a fish identified as members of the species for image-capturing, (E) capturing the image of a fish of the correct species, and (F) logging the image, along with remotely logged date and time associated with the image. In an enhanced version of the inventive method, the process includes the additional steps of (G) tagging fish passing through the image-capturing area, (H) using a viewing actuation assembly to position the image-capturing element at the correct position to capture the image of the fish, (I) directing the fish (e.g., with additional shock and/or pain if necessary) so that it will pass completely through the image-capturing area, (J) releasing a weight, when the last image is captured or when the power is nearly exhausted, to allows the device to float to the surface for collection, (K) transmitting a GPS, satellite and/or other signal to researchers so they will know where to recover the device or (L) various combinations of the foregoing additional steps with the initially presented set of steps (A)-(F).

### II. OTHER EMBODIMENTS OF THE PRESENT INVENTION WITH TAG READERS

### A. Machine Readable Tags.

There are other embodiments of the present invention that include the use of machine-readable tags. Such tags can be positioned, for example, on items to be inventoried and animals to be monitored and tracked. In such an embodiment of the inventive system, the majority of the system's functional elements may be within a housing. Such functional elements could include, for example, a reader of RFID/NFC chips, RFID/NFC tags, stickers and other comparable identifiers. Such reader, in a more mobile version of the housing, would be connected to a power source—also within the housing. Also connected to such power source would be a communications element. Such communications element could include wireless technology enabled components, through which the functional elements within the housing could exchange data and other information with components outside of the housing. Such wireless technology enabled components could include, for example, smartphones, computers and other elements with transmitters/receivers of information and storage capacity of information. Also, within the housing, connected directly or indirectly to the power source, the communications element, and the reader, could be a storage element for desirable data and other information. In one particular embodiment of the present inventive system, data and other information from external components, such as, for example, wireless technology enabled devices, can be combined with data and other information read by the reader element. This combining of data and other information can, for example, facilitate the creation of relational references (e.g. tag numbers, geographical locations, temperatures, dates, and times). As presently contemplated, a portion of the data and other information may be supplied by the physically-detached wireless technology enabled devices, while other data and other information may come from the reader, and a third source of data and other information could be the storage capacity within the housing (previously stored or stored during the operation of the system). Data and other information stored during such operation could be, for example, date and time parameters, weather, and other real- or near real-time information.

In further embodiments of the present inventive system, the reading element can read RFID or comparable numbers of the tags, while, for example, the wireless technology enabled devices supply date, time, weather, location and other information. The RFID and/or comparable numbers are preferably unique identifiers for each detected/read item. The combined information can then be stored locally and uploaded/downloaded to one or more databases when a network is available. One instance of this embodiment includes a reader located on a ship at sea or in a remote location where WIFI, internet, cellphone and comparable communication service is unavailable. In such an instance, the system could store data and other information in the storage capacity until it can be uploaded/downloaded.

To be clear, the readable tags can take the form of, for example, any type of RFID/NFC tag or QR code tag. Such classification of tags or other identifiers could include, by way of further example, embedded animal RFID/NFC tags, sticker-based RFID/NFC or QR code tags, hardened RFID/NFC and/or QR tags on heavy equipment, RFID/NFC codes on heavy equipment, RFID/NFC and/or QR codes in or on crates/items in warehouses, etc.

### B. Recording of Images and Audio

In more enhanced embodiments of the present inventive system, the functional components include recording capabilities. This recording element provides the functionality through which the device, in addition to reading tags, can capture images (e.g., take photographs), record sounds (e.g. receive verbal descriptions), document the positions/locations of the device during its use, perform other recordation, or a combination of the foregoing. By way of further example, the device could record audio directly, which can then be transmitted to the wireless technology enabled device (e.g., a cellphone or computer). From such enabled wireless technology device or in a separate device or set of devices electronically connected with the wireless technology enabled device (e.g., via the Internet), the recorded data or other information could be further or later analyzed (e.g., using voice recognition technology in connection with recorded descriptions to create text to be associated with a specified tag number). This voice recording operation, for instance, allows a person operating the system to record item and other details without having to write them down. In operation, the person could, for example, provide a detailed description of a fish that was caught and tagged (length, weight, etc.) or a description of the tagged item (e.g., the condition when the item tagged, condition when re-examined, etc.). The image-capturing capabilities (e.g., a built-in camera) could facilitate the digital recording of QR codes read, making it suitable for both RFID/NFC or QR code tagging systems, which can be used separately or interchangeably. In addition, the images can be used by an image analysis/recognition system to obtain further information about the tagged object or animal. If an object, the system will identify what it is. If an animal, it will extract information such as length, weight, species, gender and health. When combined with other data collected during the tagging process the system creates a detailed record of exactly what was tagged along with where, when and any other information specific to that tagging event (such as weather, who did the tagging, etc.).

### C. Storage

In certain embodiments of the present inventive system (as suggested above), a storage capacity element for selected data and other information could be within the housing of the device. With this form of storage capacity element, the device can store data or other information for real- or near real-time use and/or until it can be uploaded/downloaded. Audio files, for example, can be saved along with other data and other information if speech recognition is not effective, such as occasions where people have a strong accent or are logging data in a language that the recognition system does not know. In a more enhanced embodiment, audio recognition technology is also included within the housing. Human and/or autonomous recognition systems could be used alongside of such audio recognition technology in the recognition and analysis of captured images in real time or later (e.g., identifying a species of fish after the tagging process was completed). The audio system can also be used to associate a tag number so that the device can be used to identify the tag matching the item being sought (e.g. “This box contains the blue toaster”—with such statement associating, within the storage capacity database, the tag read, the location of the box in the warehouse, the image of the box, the fact that the box includes a toaster, and the color of the toaster as being blue). The stored data and other information also supports an operation in which, for example, a system user could be alerted, via the phone, another wireless technology enabled device, or directly with the reader device itself, when the box with the ‘blue toaster’ is moved (e.g., when the tagged number is scanned during transport of the box)—as the next reader device detects the tag, it illuminates an LED on the tag, plays a sound, causes a sound to be played by the phone with which it is communicating, performs some other ‘alerting’ function, or a combination of the foregoing.

By way of further example, in one instance in the use of the inventive system and method, a user reads a tag when that user moves the box. In another instance, there are passive sensors that note the movement of the box and automatically notify and/or update the database that the box has moved (this approach is especially useful in the prevention of pilferage). In yet another instance, when the box is moved, the system both updates the database (in which a history of changes to the tag, such as prior movements, changes in contents, and more, is maintained) as well as notifies a system user via an alert. For example, when the valuable box has been moved, the owner of the warehouse could be notified.

Much as the above examples where the system tracks whether a box/item has been moved, another example involves detecting changes in the contents of the box automatically via changes in weight. In this instance, there are passive sensors that note the current weight of the box and automatically and/or update the database that the weight of the box has been changed (again, useful to track pilferage). In yet another instance, the changes in “weight” (which is really the force of the box on the weight sensors) can indicate whether someone has opened the box and/or altered the contents, as the act of opening and placing/removing items will result in a sensed force-time (weight change) history that is unique to such opening/accessing activities.

Similarly, if a user were looking for a specific, already-tagged item, the user could be alerted when they are approaching the location of the tagged item, e.g. the reader (or even an app on a portable device such as a phone or tablet) lights up, plays a sound, vibrates or does something when the user is near the tagged item.

In another use of the system, when an item is moved/altered/accessed, the user can be automatically alerted to update information about the tagged item that is not automatically recorded. For example, if the box is accessed and something is removed, the system can remind the user to update the listing of the contents to reflect the change, or alert security that a box is now lighter/heavier than it was before.

### D. Association of Data

Still another embodiment of the present inventive system includes technology through which captured data and other information can be associated and/or compared with loaded or to be loaded data or other information. The teaching above refers to such association and comparison functionality. In this particular embodiment, the element through which such association and comparison function is performed within the housing. With the use of such functionality, for example, a photograph can be used for identification or as data recorded and stored along with a RFID number (e.g. “this is a photo of the bicycle to which we found the tag attached” or “this is a photo of the fish to which we attached the tag”). The association can also be used in the reverse fashion, where the item picture can be used to determine a specific tag that can then be scanned (e.g., “This is the blue box I was looking for. It has tag number NNNN attached to it, so I will now go scan the warehouse for tag number NNNN” or “Tag number NNNN is on a box that looks like this attached picture”).

### E. Security

An additional element that could be incorporated into an embodiment of the present inventive system is information securing technology. This element may be warranted if security, traceability, history, or any other use specific attributes are of concern. Through the use of such technology, the data or other information can be secured, for example, through the use of blockchain technology. Such securing facilitates, for instance, the monitoring of the system, device and records of the data and/or information including the history of changes to the information and/or objects associated with the tag.

### III. EMBODIMENTS OF THE PRESENT INVENTION WITHOUT TAG READERS

### A. Identification by Image as Opposed to Via Tags.

In a different series of embodiments of the present invention, the presence or existence of a tag is not a requirement in the identification and capturing of information about an item. This series of embodiments utilizes, among other information, the location of the target item when it is identified and information about it and its circumstances is captured, possibly a record of the date and time of identification and capture, and an image of the item. The location, date, and image are processed along with stored data to produce additional information about the item (like, for instance, confirmation of the identification, the physical attributes of the item, and other item specific information that is current in time).

With the information about collections of items captured, the user of the system can, for example, identify and track the spread of invasive species identified. By way of further example, if a fish that is caught and logged at a particular time and place in which it was caught, the system, identifying the fish by its image, can flag the user if the caught fish is not in the group that would naturally be in that place at that time. This kind of information helps with, for example, the tracking of migration of native species due to climate change and/or the arrival of invasive species into a given geographic area.

### B. The Reader.

In one embodiment of the inventive system for which tags are not required, the majority of the system's functional elements may still nevertheless be within a housing. Such functional elements could include, for example, an element that is capable of capturing a desirable image of the item in question. The image-capturing capabilities could be provided through the incorporation of built-in camera or other image capture technology. Such a reader, in a more mobile version of the housing, would be connected to a power source—also within the housing. Also connected to such power source would be a communications element. Such communications element could include wireless technology enabled components, through which the functional elements within the housing could exchange data and other information with components outside of the housing.

Such wireless technology enabled components could include, for example, smartphones, computers and other elements with transmitters/receivers of information and storage capacity of information. Also, within the housing, connected directly or indirectly to the power source, the communications element, and the reader, could be a storage element for desirable data and other information. In one particular embodiment of the present inventive system, data and other information from external components, such as, for example, wireless technology enabled devices, can be combined with data and other information captured or otherwise available at the time the image of the item in question is captured. This combining of data and other information can, for example, facilitate the creation of relational references (e.g. identification numbers, geographical locations, temperatures, dates, and times). As presently contemplated, a portion of the data and other information may be supplied by the physically-detached wireless technology enabled devices, while other data and other information may come from the reader, and a third source of data and other information could be the storage capacity within the housing (previously stored or stored during the operation of the system). Data and other information stored during such operation could be, for example, date and time parameters, weather, and other real- or near real-time information.

In further embodiments of the present inventive system, the image-capturing element can capture the desired image, while, for example, the wireless technology enabled devices supply date, time, weather, location and other information. The image-capturing element is also preferable electronically connected with a comparison element, either within the housing or remotely accessible. The comparison element is electronically connected to a database with information that facilitates the identification of the item captured in the image via analysis within the comparison element. All of the information (e.g., the captured image, the identification information, the date of the image capture, the attributes of the item, the time of the image capture and/or comparison, and other useful information) can then be stored locally and uploaded/downloaded to one or more databases when a network is available. One instance of this embodiment includes a device of the inventive system located on a ship at sea or in a remote location where WIFI, internet, cellphone and comparable communication service is unavailable. In such an instance, the system could store, for example, images, data and other information in the storage capacity until it can be uploaded/downloaded.

### B. Recording of Images and Audio

Like in the embodiments of the present inventive system in which the device includes a tag reader, in more enhanced embodiments of the present inventive system in which images are captured, the functional components include recording capabilities. This recording element provides the functionality through which the device, in addition to capturing images (e.g., take photographs), could read tags, record sounds (e.g. receive verbal descriptions), document the positions/locations of the device during its use, perform other recordation, or a combination of the foregoing. By way of further example, the device could record audio directly, which can then be transmitted to the wireless technology enabled device (e.g., a cellphone or computer). From such enabled wireless technology device or in a separate device or set of devices electronically connected with the wireless technology enabled device (e.g., via the Internet), the recorded data or other information could be further or later analyzed (e.g., using voice recognition technology in connection with recorded descriptions to create text to be associated with a specified tag number). This voice recording operation, for instance, allows a person operating the system to record item and other details without having to write them down. In operation, the person could, for example, provide a detailed description of a fish that was caught and ‘photographed’ (length, weight, etc.) or a description of the ‘photographed’ item (e.g., the condition when the item ‘photographed’, condition when re-examined, etc.).

In addition, the images can be used by an image analysis/recognition system (e.g., the comparison element) to obtain further information about the ‘photographed’ item. If an object, the system will identify what it is. If an animal, it will extract information such as length, weight, species, gender and health. When combined with other data collected during the processing the system creates a detailed record of exactly what was item whose image was captured along with where, when and any other information specific to that capturing of the image (such as weather, who did the image-capturing, etc.).

### Additional Thoughts

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive system may look and how the inventive process may be performed. Further, other elements and/or steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed is:

1. A system of tagging fish and capturing the information related the fish comprising:
a frame;
a fish lure physically connected to the frame;
a power source physically connected to the frame;
sensor physically connected to the frame and electronically connected to the power source;
a reader connected to the frame and electronically connected to the power source;
wireless technology physically connected to the frame and electronically connected to the power source;
multi-axis tagging actuation assembly physically connected to the frame and electronically connected to the power source, and
fish ejector physically connected to the frame and electronically connected to the power source;
wherein, the fish can be lured into a location proximate to the frame by the fish lure, the sensor can sense the presence of the fish, the reader can read any tag already attached to the fish, the multi-axis tagging actuation assembly can affix a tag on the fish if a tag is not already attached, the fish ejector can, as warranted, facilitate the exiting of the fish from within the frame and, via the wireless technology, information related to the fish tagging can be communicated to a remote device, such that, with the remote device, tag information, location information, temperature readings, date, time, and other information can be record in at least near-real time.

2. The system in claim 1 further comprising data storage connected to the frame and electronically connected to the power source, the sensor and the reader.

3. The system of claim 1 wherein the information related to the fish tagging can be communicated to remote device is provided in a form in which the information can combined with information from the remote device and the combined information can be stored locally in a database.

4. The system of claim 1 wherein the multi-axis tagging actuation assembly can move in relation to the frame in and out of a passage of frame.

5. The system of claim 1 further comprising recording capabilities connected to the frame and electronically connected to the power source and the wireless technology.

6. A system of capturing the image of fish and other information related the fish comprising:
a frame;
a fish lure physically connected to the frame;
a power source physically connected to the frame;
sensor physically connected to the frame and electronically connected to the power source;
multi-axis viewing actuation assembly physically connected to the frame and electronically connected to the power source;
an image-capturing element connected to the multi-axis viewing actuation assembly and electronically connected to the power source;
wireless technology physically connected to the frame and electronically connected to the power source; and
fish ejector physically connected to the frame and electronically connected to the power source;
wherein, the fish can be lured into a location proximate to the frame by the fish lure, the sensor can sense the presence of the fish, the multi-axis viewing actuation assembly move the image-capturing element in relation to a path through which fish are directed, the image-capturing element can view and capture an image of the fish, the fish ejector can, as warranted, facilitate the exiting of the fish from within the frame and, via the wireless technology, information related to the fish viewed and whose image has been captured can be communicated to a remote device, such that, with the remote device, the captured image, location information, temperature readings, date, time, and other information can be record in at least near-real time.

7. The system in claim 6 further comprising data storage connected to the frame and electronically connected to the power source, the sensor and the image-capturing element.

8. The system of claim 6 wherein the image capture of the fish can be communicated to remote device in a form in which the image can combined with information from the remote device and the combined information can be stored locally in a database.

9. The system of claim 6 further comprising recording capabilities connected to the frame and electronically connected to the power source and the wireless technology.

10. The system of claim 6 further comprising a tagging element, connected to the frame and electronically connected to the power source, the image capturing element, and the wireless technology.

11. A method of tagging fish and capturing the information related the fish comprising the steps of:
positioning a lure in a fixed location to facilitate the swimming of fish proximate to the tagging area at such fixed location;
detecting fish passing toward the tagging area;
redirecting a fish for ejection if such fish is not a member of the correct species;
scanning a fish identified as members of the species for tagging;
tagging a fish of the correct species, after identifying a spot on the fish for the tag; and
logging the tag information, along with remotely logged date and time images relevant to the fish tagging.

12. A method of claim 11 further comprising the step of capturing images of fish passing through the tagging area.

13. A method of claim 11 further comprising the step of using a tagging actuation assembly to position the tagger element at the correct position to attach the tag to the fish

14. A method of claim 11 further comprising the step of directing the fish so that the fish will pass completely through the tagging area.

15. A method of claim 11 further comprising the steps of
releasing a weight, when the last tag is used or when the power is nearly exhausted, to allows the device to float to the surface for collection; and
transmitting a signal to researchers so they will know where to recover the device.

16. A method of capturing an image of fish and information related the fish comprising the steps of:
positioning a lure in a fixed location to facilitate the swimming of fish through the image-capturing area at such fixed location;
detecting fish passing toward the image-capturing area;
redirecting a fish for ejection if such fish is not a member of the correct species;
scanning a fish identified as members of the species for image-capturing;
capturing the image of a fish of the correct species; and
logging the image, along with remotely logged date and time associated with the image.

17. A method of claim 16 further comprising the step of tagging fish passing through the image-capturing area.

18. A method of claim 16 further comprising the step of using a viewing actuation assembly to position the image-capturing element at the correct position to capture the image of the fish.

19. A method of claim 16 further comprising the step of directing the fish so that it will pass completely through the image-capturing area.

20. A method of claim 16 further comprising the step of
releasing a weight, when the last image is captured or when the power is nearly exhausted, to allows the device to float to the surface for collection and
transmitting a signal to researchers so they will know where to recover the device.
